(19) United States
(12) Patent Application Publication
(10) Pub. No.: US 2013/0016239 A1
(43) Pub. Date: Jan. 17, 2013

(54) METHOD AND APPARATUS FOR REMOVING NON-UNIFORM MOTION BLUR USING MULTI-FRAME

(71) Applicants: Jung Uk CHO, Hwaseong-si (KR); Seung Yong LEE, Pohang-si (KR); Sung Hyun CHO, Pohang-si (KR); Shi Hwa LEE, Seoul (KR); Young Su MOON, Seoul (KR); Ho Jin CHO, Pohang-si (KR)

(72) Inventors: Jung Uk CHO, Hwaseong-si (KR); Seung Yong LEE, Pohang-si (KR); Sung Hyun CHO, Pohang-si (KR); Shi Hwa LEE, Seoul (KR); Young Su MOON, Seoul (KR); Ho Jin CHO, Pohang-si (KR)

(73) Assignees: Postech Academy-Industry Foundation, Pohang-si (KR); Samsung Electronics Co., Ltd, Suwon-si (KR)

(21) Appl. No.: 13/415,285

(22) Filed: Mar. 8, 2012

(30) Foreign Application Priority Data
Jul. 11, 2011 (KR) 10-2011-0068511

(51) Int. Cl. H04N 5/228; G06K 9/40

(52) U.S. Cl. 348/208.4; 382/255; 348/E05.031

(57) ABSTRACT

A method and apparatus for removing a non-uniform motion blur using a multi-frame may estimate non-uniform motion blur information using a multi-frame including a non-uniform motion blur, and may remove the non-uniform motion blur using the estimated non-uniform motion blur and the multi-frame. The apparatus may also obtain more accurate non-uniform motion blur information by iteratively performing the estimation of the non-uniform motion blur information, and the removal of the non-uniform motion blur.

### CROSS-REFERENCE TO RELATED APPLICATIONS

This application claims the priority benefit of Korean Patent Application No. 10-2011-0068511, filed on Jul. 11, 2011, in the Korean Intellectual Property Office, the disclosure of which is incorporated herein by reference.

### BACKGROUND

1. Field

Example embodiments relate to an image processing method, and more particularly, to a method and apparatus for removing a blur from an image.

2. Description of the Related Art

A blur is a phenomenon which commonly occurs during a process of obtaining an image while using an apparatus for obtaining an image. The blur phenomenon is one of the main contributors to deterioration of image quality.

When an image is obtained using an apparatus, for example, a camera, and the like, in an environment where an amount of light is insufficient, for example, a dark indoor location, or an outdoor location in the evening, a sufficient amount of light is required to obtain a clear image. Accordingly, an image sensor may be exposed to light for a longer period of time than usual. However, when an exposure time is too long, a blur may occur in the obtained image due to the image sensor being shaken.

There is a method of correcting an image using a deblurring technique for a case in which an entire image has a uniform motion blur occurring due to a translation of a camera. However, each pixel of an image generally can include a blur in different directions and of different sizes due to a translational motion and rotational motion of a camera, that is, a non-uniform motion blur.

### SUMMARY

The foregoing and/or other aspects may be achieved by providing a method of removing a non-uniform motion blur using a multi-frame, the method may include receiving a multi-frame including a non-uniform motion blur, estimating non-uniform motion blur information using the multi-frame, and obtaining a latent image by removing the non-uniform motion blur from the multi-frame using the estimated non-uniform motion blur information.

The multi-frame may include a first image and a second image, and the estimating of the non-uniform motion blur information may include estimating non-uniform motion blur information of the second image based on the first image, and estimating non-uniform motion blur information of the first image based on the second image.

The estimating of the non-uniform motion blur information may include estimating a homography of each image included in the multi-frame, and computing a weight of the homography of each image based on the estimated homography.

The estimating of the homography may include estimating the homography using the Lucas-Kanade image registration algorithm.

The estimating of the homography and the computing of the weight may be iteratively performed a predetermined number of times.

The estimating of the non-uniform motion blur information and the obtaining of the latent image may be iteratively performed in accordance with a predetermined criterion, and the estimating of the non-uniform motion blur information may include updating the non-uniform motion blur information using a latent image obtained from a previous iteration.

The method may further include obtaining a final restored image from the multi-frame using final non-uniform motion blur information obtained by the iteration.

The estimating of the non-uniform motion blur information may include estimating the non-uniform motion blur information using at least one of a Euclidean transform, and a translational and rotational motion of a camera using an intrinsic parameter of the camera.

The estimating of the non-uniform motion blur information may include estimating the non-uniform motion blur information for a partial region of each image included in the multi-frame, and the obtaining of the latent image may include obtaining the latent image using non-uniform motion blur information of the partial region.

The foregoing and/or other aspects may be achieved by providing an apparatus for removing a non-uniform motion blur using a multi-frame, the apparatus may include a receiving unit to receive a multi-frame including a non-uniform motion blur, a non-uniform motion blur information estimating unit to estimate non-uniform motion blur information using the multi-frame, and a latent image obtaining unit to obtain a latent image by removing the non-uniform motion blur from the multi-frame using the estimated non-uniform motion blur information.

The multi-frame may include a first image and a second image, and the non-uniform motion blur information estimating unit may estimate non-uniform motion blur information of the second image using the first image, and may estimate non-uniform motion blur information of the first image using the second image.

The non-uniform motion blur information estimating unit may estimate a homography of each image included in the multi-frame, and may compute a weight of the homography of each image using the estimated homography.

The non-uniform motion blur information estimating unit may estimate the homography using the Lucas-Kanade image registration algorithm.

The non-uniform motion blur information estimating unit may estimate the non-uniform motion blur information by iteratively performing the estimation of the homography and the computation of the weight a predetermined number of times.

The latent image obtaining unit may feed the obtained latent image back to the non-uniform motion blur information estimating unit, and the non-uniform motion blur information estimating unit may update the non-uniform motion blur information using the fed back latent image.

The apparatus may further include a final restored image obtaining unit to obtain a final restored image from the multi-frame using the updated non-uniform motion blur information.

The non-uniform motion blur information estimating unit may estimate the non-uniform motion blur information using at least one of a Euclidean transform, and a translational and rotational motion of a camera using an intrinsic parameter of the camera.

The non-uniform motion blur information estimating unit may estimate the non-uniform motion blur information for a partial region of each image included in the multi-frame, and the latent image obtaining unit may obtain the latent image using non-uniform motion blur information of the partial region.

Example embodiments may include a method of removing a non-uniform motion blur, which may estimate non-uniform motion blur information using a multi-frame including a non-uniform motion blur, and may remove the non-uniform motion blur using the estimated non-uniform motion blur information and the multi-frame, thereby restoring a clear image.

Example embodiments may also include a method of removing a non-uniform motion blur, which may iterate a process of estimating non-uniform motion blur information using a multi-frame, and a process of removing a non-uniform motion blur, thereby obtaining more accurate non-uniform motion blur information.

Example embodiments may also include a method of removing a non-uniform motion blur, which may employ various methods of indicating a non-uniform motion blur, for example, a homography, a Euclidean transform, a translation and rotational transform of a camera, and the like, thereby increasing an estimation rate of the non-uniform motion blur.

Example embodiments may also include a method of removing a non-uniform motion blur, which may estimate non-uniform motion blur information using a partial region of a multi-frame image, and may remove a blur of the multi-frame of an original resolution using the estimation non-uniform motion blur information, thereby increasing a rate of removing a blur of an image having a high resolution.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an apparatus for removing a non-uniform motion blur using a multi-frame according to example embodiments;

FIG. 2 illustrates a process of estimating non-uniform motion blur information according to example embodiments;

FIG. 3 illustrates an example of estimating rotational motions of a camera by increasing a resolution according to example embodiments; and

FIG. 4 illustrates a method of removing a non-uniform motion blur using a multi-frame according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

When it is determined that a detailed description is related to a related known function or configuration which may make the purpose of the present disclosure unnecessarily ambiguous in the description, such detailed description will be omitted. Also, terminologies used herein are defined to appropriately describe the exemplary embodiments and thus may be changed depending on a user, the intent of an operator, or a custom. Accordingly, the terminologies must be defined based on the following overall description of this specification.

Generally, a motion blur may be expressed by Equation 1.

B=K*L+N, Equation 1

where B denotes a blurred image, and K denotes a Point Spread Function (PSF) or a motion blur kernel indicating blur information of an image. L denotes a latent image, that is, a clear image without a blur. N denotes a noise occurring during a process of obtaining an image, and * denotes a convolution operator.

Equation 1 may be expressed by Equation 2 in a vectorial form.

$$b = {\sum }_{i} {w}_{i} {T}_{i} 1 + n , \qquad Equation 2$$

where b, l, and n denote vector expressions of B, L, N of Equation 1. T; denotes a matrix indicating a translational motion of a camera at a point in time tᵢ, and wᵢ denotes a relative length of time when the camera stops at the point in time tᵢ, that is, an exposure time of the camera at the point in time tᵢ. Here, Σᵢwᵢ=1.

Equation 2 may indicate that the blurred image b may be expressed using a sum of clear images l at each point Tᵢ on a route of the camera.

The clear image l may be computed using a motion blur model of Equation 1 or Equation 2. In this instance, since it may be assumed that all pixels included in an image may be uniformly moved, it may be difficult to remove a non-uniform motion blur occurring due to a rotational motion, rather than a translational motion of a camera, using a motion blur model for estimating a clear image, that is, a latent image.

Example embodiments may provide a method of removing a non-uniform motion blur using a non-uniform motion blur model that may indicate a non-uniform motion blur different from the non-uniform motion blurs of Equation 1 and Equation 2.

When shaking of a camera includes a non-translational motion, a non-uniform motion blur model as expressed by Equation 3 may be derived by substituting Tᵢ of Equation 2 with a homography Pᵢ.

$$b = {\sum }_{i} {w}_{i} {P}_{i} 1 + n \qquad Equation 3$$

In the method of removing the non-uniform motion blur of the image, blind motion deblurring may be performed using Equation 3. In the blind motion deblurring, the latent image l and the non-uniform motion blur information Pᵢ and wᵢ may be computed using the input image b.

The method of removing the non-uniform motion blur of the image may include an operation of estimating non-uniform motion blur information and an operation of obtaining a latent image, in order to obtain the non-uniform motion blur information Pᵢ and wᵢ and the latent image l that may satisfy Equation 3. The two operations may be iteratively processed. In the method of removing the non-uniform motion blur of the image, accuracies of P and w indicating the non-uniform motion blur information may be progressively refined through the iterative process.

A final restored image from which the non-uniform motion blur is removed may be obtained using finally computed non-uniform motion blur information Pᵢ and wᵢ and the image b including the non-uniform motion blur. A latent image, obtained during a process of iteratively performing the obtaining of the latent image and the estimation of the non-uniform motion blur information, may influence the estimation of the non-uniform motion blur information Pᵢ and wᵢ, thereby indirectly influencing the final restored image from which the non-uniform motion blur is removed.

In the method of removing the non-uniform motion blur of the image, the operation of estimating the non-uniform motion blur information may be performed using an image registration algorithm. The operation of estimating the non-uniform motion blur information may include an operation of estimating i) a homography P indicating a non-uniform motion blur, and an operation of computing ii) a weight w of the corresponding homography. When the latent image l is provided, the operation of estimating the non-uniform motion blur information may include an operation of computing the homography P indicating the non-uniform motion blur. In order to compute the homography, Equation 3 may be modified to Equation 4.

$$b - {\sum }_{j \neq i} {w}_{j} {P}_{j} 1 = {w}_{i} {P}_{i} 1 + n \qquad Equation 4$$

In the method of removing the non-uniform motion blur of the image, in order to compute a single homography Pᵢ in Equation 4, the homography Pi reducing a difference between

$$b - {\sum }_{j \neq i} {w}_{j} {P}_{j} 1$$

of the left side and wᵢPᵢ1 of the right side may be computed using an image registration algorithm. An entire homography set P may be obtained by computing every Pᵢ while changing an index i of each homography Pᵢ.

When the entire homography P is computed, a weight w of the homography may be computed using the computed homography P. In order to compute the weight w, Equation 3 may be modified to Equation 5.

b=Lw+n Equation 5

where L=[P₁1 P₂1 . . . Pₙ1] and L corresponds to an m-by-n (m×n) matrix. Here, m denotes a number of pixels included in an image, and n denotes a number of homographies. Generally, m>>n, and the weight w may have a value greater than 0 in Equation 5. Accordingly, the weight w may be computed using a non-negative least square method. In order to use the non-negative least square method, Equation 5 may be expressed by Equation 6 in a form of a normal equation. The weight may be computed using Equation 6.

w=(L^{T}L+βI)⁻¹L^{T}b, Equation 6

where β denotes a normalized parameter for resolving a case in which an inverse matrix of a determinant in parenthesis is absent. I denotes an identity matrix.

That is, in the operation of estimating the non-uniform motion blur information, the optimized weight w and homography P corresponding to the given latent image l may be computed through the iterative resolution of Equation 4 and Equation 6.

In the operation of estimating the non-uniform motion blur information, the non-uniform motion blur information may be iteratively updated at every time when the latent image l is updated. The optimized latent image l and the final non-uniform motion blur information P and w corresponding to the latent image l may be computed, through the iterative process.

In the operation of obtaining the latent image, the latent image l may be obtained by solving Equation 7.

$$arg {min}_{1} {‖ b - {\sum }_{i} {w}_{i} {P}_{i} 1 ‖}^{2} + {λ}_{1} {P}_{1} ( 1 ) , \qquad Equation 7$$

where P₁(1)=(∥Dₓ1∥_{α})^{α}+(∥D_{y}1∥_{α})^{α}, and λ₁ denotes a weight of P₁. ∥x∥_{α} denotes an L−α norm of a vector.

Since a flat region occupies a larger portion than a clear edge region in a general nature image, it may be important to restrain a noise in the flat region. Also, it may be important to effectively restore a clear edge. According to example embodiments, sparseness prior may be used to resolve the foregoing problem. In this instance, α=0.8.

In Equation 7, the latent image l may be computed using an iterative reweighted least square method. In particular, the latent image l may be computed by obtaining an approximate value of a normalized term of Equation 8.

$$arg {min}_{1} {‖ b - {\sum }_{i} {w}_{i} {P}_{i} 1 ‖}^{2} + {1}^{T} {D}_{x}^{T} {W}_{x} {D}_{x} 1 + {1}^{T} {D}_{y}^{T} {W}_{y} {D}_{y} 1 , \qquad Equation 8$$

where Wₓ and W_{y} denote diagonal matrices. A k^{th} diagonal element of Wₓ corresponds to λ₁|Dₓ1(k)|^{α-2}, and a k^{th} diagonal element of W_{y} corresponds to λ₁|D_{y}1(k)|^{α-2}. Dₓ1(k) denotes a k^{th} element of a vector Dₓ1, and D_{y}1(k) denotes a k^{th} element of a vector D_{y}1. The latent image l according to Equation 8 may be computed by applying a conjugate gradient method to Equation 9.

(Q^{T}Q+Dₓ^{T}WₓDₓ+D_{y}^{T}W_{y}D_{y})1=Q^{T}b Equation 9

where

$$Q = {\sum }_{i} {w}_{i} {P}_{i} .$$

The foregoing model may correspond to a model in a case where a blurred image b is a single frame. The model may require a process of predicting the latent image l in the operation of estimating the non-uniform motion blur information using the image registration algorithm using Equation 4. Here, the latent image used for the estimation of the non-uniform motion blur information may directly influence a performance of the image registration algorithm, and also may influence quality of deblurring results. According to example embodiments, a multi-frame may be used to stably provide a latent image of a higher quality.

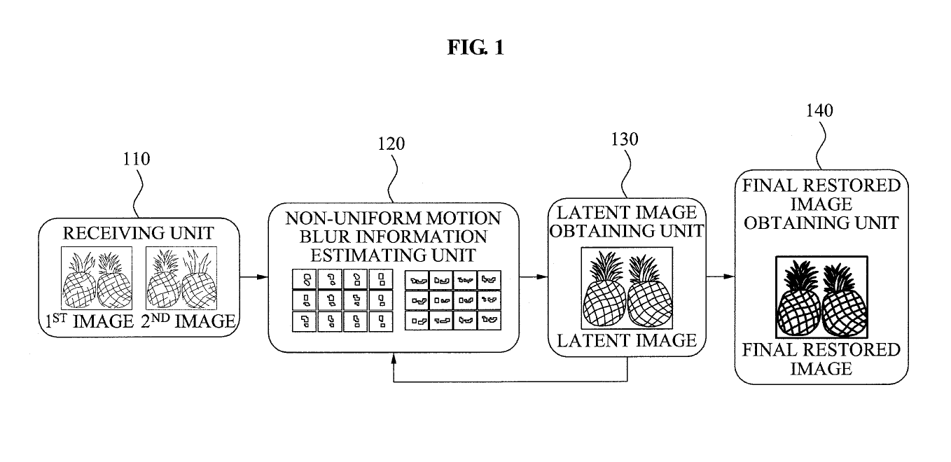

FIG. 1 illustrates an apparatus for removing a non-uniform motion blur using a multi-frame according to example embodiments.

Referring to FIG. 1, the apparatus for removing a non-uniform motion blur using a multi-frame, which will be hereinafter referred to as the apparatus, may include a receiving unit 110, a non-uniform motion blur information estimating unit 120, a latent image obtaining unit 130, and a final restored image obtaining unit 140.

The receiving unit 110 may receive a multi-frame including a non-uniform motion blur. The receiving unit 110 may convert the multi-frame to a grayscale image, and may provide the multi-frame to the non-uniform motion blur information estimating unit 120.

The non-uniform motion blur information estimating unit 120 may estimate non-uniform motion blur information using the received multi-frame. In particular, the non-uniform motion blur information estimating unit 120 may estimate a homography of each image included in the multi-frame, and may compute a weight of the homography of each image using the estimated homography. The homography may be estimated using the Lucas-Kanade image registration algorithm. In this instance, the non-uniform motion blur information estimating unit 120 may more accurately estimate the non-uniform motion blur information by iteratively performing the estimation of the homography and the computation of the weight a predetermined number of times.

The latent image obtaining unit 130 may obtain a latent image by removing the non-uniform motion blur from the multi-frame using the non-uniform motion blur information. The latent image obtaining unit 130 may feed the obtained latent image back to the non-uniform motion blur information estimating unit 120.

The final restored image obtaining unit 140 may obtain a final restored image from the multi-frame using the non-uniform motion blur information or updated non-uniform motion blur information. In other words, the final restored image obtaining unit 140 may perform deconvolution. That is, the final restored image obtaining unit 140 may obtain the final restored image by applying final non-uniform motion blur information to each of red, green, blue (RGB) of the multi-frame which is converted to be grayscale.

The non-uniform motion blur information estimating unit 120 may receive the latent image from the latent image obtaining unit 130. The non-uniform motion blur information estimating unit 120 may update the non-uniform motion blur information, that is, re-estimate the non-uniform motion blur information using the received latent image. The latent image obtaining unit 130 may update the latent image using the updated non-uniform motion blur information. The non-uniform motion blur information estimating unit 120 and the latent image obtaining unit 130 may iteratively perform the foregoing processes, thereby obtaining non-uniform motion blur information and a latent image of a higher quality. In accordance with an increase in a number of times that the processes may be iterated, the non-uniform motion blur information may converge to be similar to information about an actual motion of a camera being shaken. Also, the latent image used for the estimation of the non-uniform motion blur information may be clearer in accordance with an increase in the number of times that the processes may be iteratively performed. However, the latent image during the iterative processes may be used only for the estimation of the non-uniform motion blur information, and may not influence the final restored image directly. The iterative processes may be continuously performed until non-uniform motion blur information and a latent image of a predetermined quality are obtained.

When the non-uniform motion blur information estimating unit 120 initially estimates a non-uniform motion blur, each image included in the multi-frame may be used, as a latent image, to estimate blur information of the other image. That is, when the multi-frame includes a first image and a second image, the non-uniform motion blur information estimating unit 120 may estimate non-uniform motion blur information of the second image using the first image, and may estimate non-uniform motion blur information of the first image using the second image. Accordingly, an accuracy of the estimation of the non-uniform motion blur information may increase.

The non-uniform motion blur information estimating unit 120 may update the non-uniform motion blur information by re-estimating the non-uniform motion blur information of each image included in the multi-frame, using the latent image which is fed back from the latent image obtaining unit 130, and from which the non-uniform motion blur is removed.

In particular, in the method of removing the non-uniform motion blur of the image, a quality of the latent image from which the blur is removed may be increased by applying Equation 7 to at least two pieces of images. Equation 7 may be applied as expressed by Equation 10, in order to be applied to the multi-frame.

$$arg {min}_{1} {\sum }_{k} {‖ {b}_{k} - {\sum }_{i} {w}_{( k , i )} {P}_{( k , i )} 1 ‖}^{2} + {λ}_{1} {P}_{1} ( 1 ) , \qquad Equation 10$$

where P_{(k,i)} denotes an i^{th} homography of a k^{th} image Bₖ including a non-uniform motion blur, and w_{(k,i)} denotes an i^{th} weight of the k^{th} image Bₖ including the non-uniform motion blur.

In the method of removing the non-uniform motion blur using the multi-frame including the non-uniform motion blur, the non-uniform motion blur information may be estimated and the blur may be removed in a more stable manner since each image included in the multi-frame may include different non-uniform motion blur information.

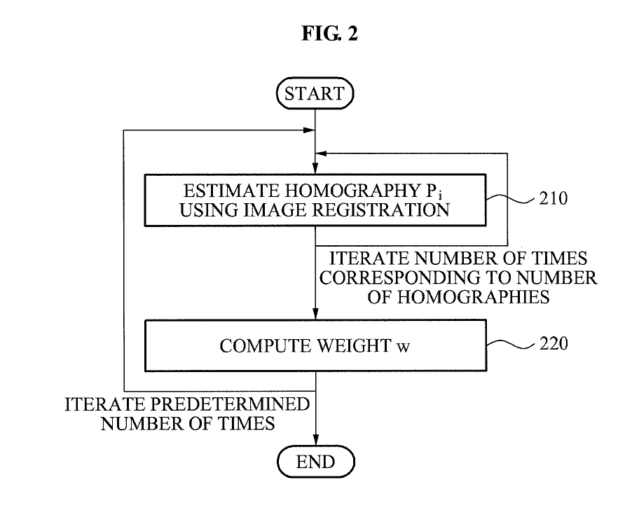

FIG. 2 illustrates a process of estimating non-uniform motion blur information according to example embodiments.

That is, FIG. 2 illustrates operations performed by a non-uniform motion blur information estimating unit according to example embodiments.

Referring to FIG. 2, in operation 210, the non-uniform motion blur information estimating unit may compute a homography Pᵢ indicating a non-uniform motion using an image registration of received images using Equation 4. The non-uniform motion blur information estimating unit may compute an entire homography P by iterating the image registration a number of times corresponding to a number of homographies, that is, a number of indices of i.

When the homography is computed, the non-uniform motion blur information estimating unit may compute a weight w using Equations 5 and 6, in operation 220.

The non-uniform motion blur information may be indicated by the homography and the weight, that is, P and w, and the non-uniform motion blur information estimating unit may iteratively perform the estimation of the homography and the computation of the weight in order to increase an accuracy of the estimation and the computation.

The homography Pᵢ may indicate a projective transform of an image pixel. According to example embodiments, the apparatus may also employ other methods of indicating blur information, in addition to the homography P.

The homography Pᵢ may require eight parameters when coordinates of a pixel are moved in a three-dimensional (3D) space, and may indicate a single motion among non-uniform motion blur information as expressed by Equation 11.

$$P = [ \begin{matrix}1 + {h}_{00} & {h}_{01} & {h}_{02} \\ {h}_{10} & 1 + {h}_{11} & {h}_{12} \\ {h}_{20} & {h}_{21} & 1\end{matrix} ] , \qquad Equation 11$$

where h₀₀, h₀₁, h₁₀, and h₁₁ denote rotations. h₀₂ denotes an x-axis translation, and h₁₂ denotes a y-axis translation. h₂₀ denotes an x-axis skew, and h₂₁ denotes a y-axis skew.

A homography is a most typical scheme of indicating a non-uniform motion. When an intrinsic parameter of a camera at a time of photographing is known, the homography of Equation 11 may be expressed as Equation 12.

$$P = K ( R + T ) {K}^{- 1} , \\ here , \\ K = [ \begin{matrix}kf & - kf / tan ( θ ) & {u}_{0} \\ 0 & lf & {v}_{0} \\ 0 & 0 & 1\end{matrix} ] , \qquad Equation 12$$

where k and l denote scale factors, f denotes a focal length, and u₀ and v₀ denote principal points.

In Equation 12, each of R and T may correspond to matrices respectively expressing a rotational transform and a translational transform in directions of x, y, and z axes of a camera in a 3D space.

Equation 12 may be used when the intrinsic parameter of the camera is known. A normalized non-uniform motion may be estimated using Equation 12, similar to a case of using the homography. Since Equation 12 may require only six parameters regarding the rotation and translation of the camera, a rate of estimating and removing a non-uniform motion blur may increase.

According to example embodiments, the apparatus may also employ a Euclidean transform expressed by Equation 13, in addition to the method of indicating a non-uniform motion blur using camera information of Equation 12.

$$P = [ \begin{matrix}{c}_{θ} & - {s}_{θ} & {t}_{x} \\ {s}_{θ} & {c}_{θ} & {t}_{y}\end{matrix} ] , \qquad Equation 13$$

where c_{θ} denotes cosine θ, s_{θ} denotes sine θ, and t denotes a translation.

Equation 13 may fail to indicate a normalized non-uniform motion identical to the normalized non-uniform motion expressed by Equation 11. However, Equation 13 may indicate a non-uniform motion under which it may be assumed that pixels included in an image may have only a translational motion in directions to an x-axis and a y-axis, and an in-plane rotational motion in the pixel coordinate system.

The motion expressed by Equation 13 may correspond to a translational transform to an x-axis and a y-axis on a plane, and an in-plane rotational transform on the plane. Three parameters may be used to indicate the non-uniform motion.

The apparatus may estimate non-uniform motion blur information using at least one of Equations 11 through 13. When a fewer number of parameters are used to estimate the non-uniform motion blur information, a processing rate may become faster. That is, the processing rate may be fast in the order of the Euclidean transform expressed by Equation 13, the use of the intrinsic parameter of the camera expressed by Equation 12, and the homography expressed by Equation 11.

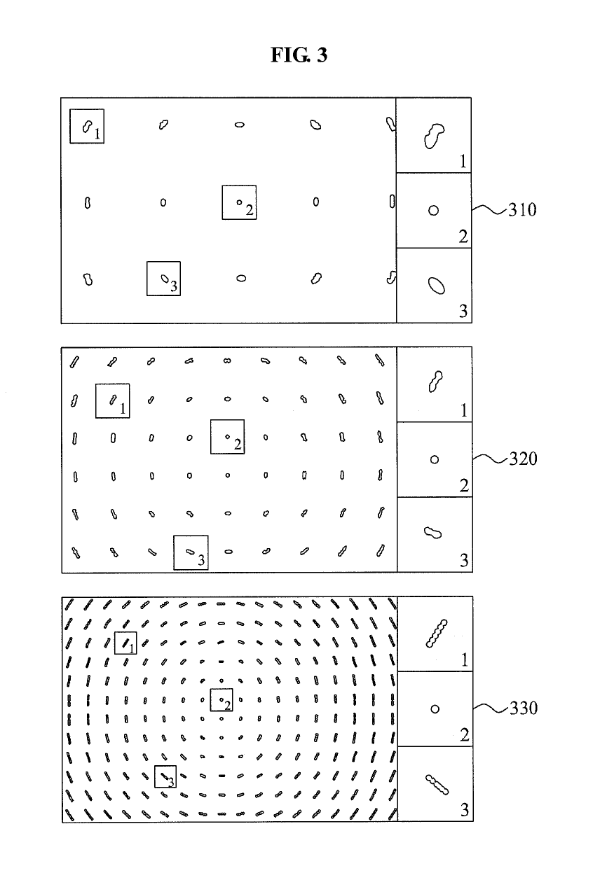

FIG. 3 illustrates an example of estimating rotational motions of a camera by increasing a resolution according to example embodiments.

An apparatus for removing a non-uniform motion blur using a multi-frame, hereinafter referred to as the apparatus, may iteratively estimate non-uniform motion blur information while changing a resolution of an image, and may obtain a latent image, thereby more effectively and accurately estimating the non-uniform motion blur information, and obtaining the latent image. That is, the apparatus may perform a multi-scale iterative process.

In particular, the apparatus may estimate non-uniform motion blur information at a low resolution so that blur information in a case of a large-scale non-uniform motion may be estimated. The apparatus may estimate information about a blur occurring due to a small motion by up-sampling the non-uniform motion blur information estimated at the low resolution.

Referring to FIG. 3, a motion blur 310 estimated at a lowest resolution, a motion blur 320 estimated at a medium resolution, and a motion blur 330 estimated at a high resolution are illustrated. The apparatus may estimate motion blur information at a low resolution, and may obtain a latent image using the estimated motion blur information. The apparatus may obtain more accurate non-uniform motion blur information, by iteratively estimating motion blur information having an increasingly higher resolution using the latent image and the motion blur information estimated at the low resolution. For example, the apparatus may crop an image having a 1500×1000 resolution to a partial region having a 600×400 resolution, and may estimate non-uniform motion blur information using the partial region of the cropped image, in order to remove a non-uniform motion blur of an image having more than 1 Megabyte of pixels. The apparatus may remove a non-uniform motion blur of the image having the original resolution, that is, the 1500×1000 resolution, using non-uniform motion blur information of the partial region of the image. A resolution of the partial region may not be limited to a predetermined size, and the apparatus may estimate non-uniform motion blur information, and may remove a non-uniform motion blur from a partial region image having any predetermined size, cropped from each image included in the multi-frame.

As aforementioned, the apparatus may perform a multi-scale iterative process, thereby estimating a blur occurring due to a large-scale motion, the blur being difficult to be controlled using a single scale. That is, the apparatus may accelerate a processing rate by first estimating a large-scale motion.

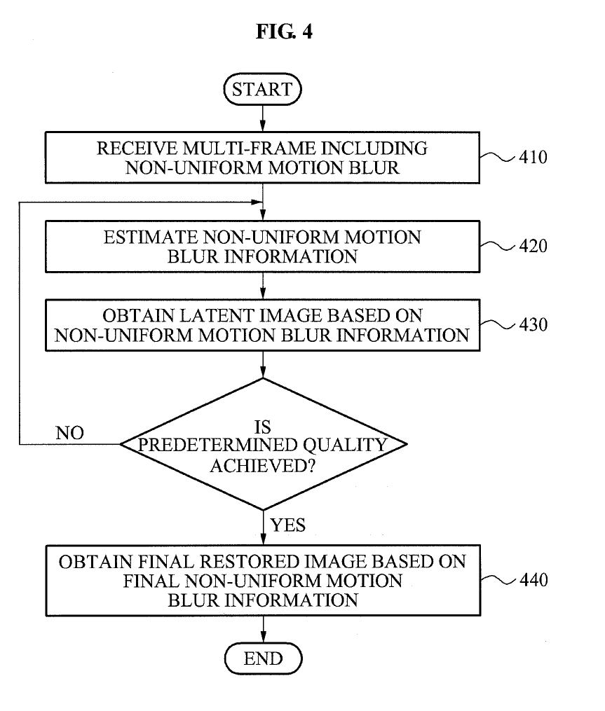

FIG. 4 illustrates a method of removing a non-uniform motion blur using a multi-frame according to example embodiments.

Referring to FIG. 4, in operation 410, a multi-frame including a non-uniform motion blur may be received.

In operation 420, non-uniform motion blur information may be estimated using the received multi-frame.

In operation 430, a latent image may be obtained by removing the non-uniform motion blur from the multi-frame using the estimated non-uniform motion blur information. In this instance, when the obtained latent image fails to satisfy a predetermined quality, the non-uniform motion blur information may be re-estimated, that is, updated, using the obtained latent image, and the latent image may be updated using the updated non-uniform motion blur information.

In operation 440, a final restoration image may be obtained from the multi-frame using the non-uniform motion blur information or updated final non-uniform motion blur information.

The method of removing the non-uniform motion blur using the multi-frame has been described. The same descriptions mentioned above by way of various example embodiments with reference to FIGS. 1 through 3 may be applied to the method and thus, a further detailed description will be omitted for conciseness.

The methods according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Any one or more of the software modules described herein may be executed by a dedicated processor unique to that unit or by a processor common to one or more of the modules. The described methods may be executed on a general purpose computer or processor or may be executed on a particular machine such as the image processing apparatus described herein.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A method of removing a non-uniform motion blur using a multi-frame, the method comprising:
receiving a multi-frame including a non-uniform motion blur;
estimating by a processor non-uniform motion blur information using the multi-frame; and
obtaining a latent image by removing the non-uniform motion blur from the multi-frame using the estimated non-uniform motion blur information.

2. The method of claim 1, wherein
the multi-frame comprises a first image and a second image, and
the estimating of the non-uniform motion blur information comprises estimating non-uniform motion blur information of the second image using the first image, and estimating non-uniform motion blur information of the first image using the second image.

3. The method of claim 1, wherein the estimating of the non-uniform motion blur information comprises:
estimating a homography of each image included in the multi-frame; and
computing a weight of the homography of each image using the estimated homography.

4. The method of claim 3, wherein the estimating of the homography comprises estimating the homography using the Lucas-Kanade image registration algorithm.

5. The method of claim 3, wherein the estimating of the homography and the computing of the weight are repeated a predetermined number of times.

6. The method of claim 1, wherein
the estimating of the non-uniform motion blur information and the obtaining of the latent image are repeated in accordance with a predetermined criterion, and
the estimating of the non-uniform motion blur information comprises updating the non-uniform motion blur information using a latent image obtained from a previous iteration.

7. The method of claim 6, further comprising:
obtaining a final restored image from the multi-frame using final non-uniform motion blur information obtained by the iteration.

8. The method of claim 1, wherein the estimating of the non-uniform motion blur information comprises estimating the non-uniform motion blur information using at least one of a Euclidean transform, and a translational and rotational motion of a camera using an intrinsic parameter of the camera.

9. The method of claim 1, wherein
the estimating of the non-uniform motion blur information comprises estimating the non-uniform motion blur information for a partial region of each image included in the multi-frame, and
the obtaining of the latent image comprises obtaining the latent image using non-uniform motion blur information of the partial region.

10. A non-transitory computer-readable medium comprising a program for instructing a computer to perform the method of claim 1.

11. An apparatus for removing a non-uniform motion blur using a multi-frame, the apparatus comprising:
a receiving unit to receive a multi-frame including a non-uniform motion blur;
a non-uniform motion blur information estimating unit to estimate non-uniform motion blur information using the received multi-frame; and
a latent image obtaining unit to obtain a latent image by removing the non-uniform motion blur from the multi-frame using the estimated non-uniform motion blur information.

12. The apparatus of claim 11, wherein
the multi-frame comprises a first image and a second image, and
the non-uniform motion blur information estimating unit estimates non-uniform motion blur information of the second image using the first image, and estimates non-uniform motion blur information of the first image using the second image.

13. The apparatus of claim 11, wherein the non-uniform motion blur information estimating unit estimates a homography of each image included in the multi-frame, and computes a weight of the homography of each image using the estimated homography.

14. The apparatus of claim 13, wherein the non-uniform motion blur information estimating unit estimates the homography using the Lucas-Kanade image registration algorithm.

15. The apparatus of claim 13, wherein the non-uniform motion blur information estimating unit estimates the non-uniform motion blur information by performing the estimation of the homography and the computation of the weight, iteratively, a predetermined number of times.

16. The apparatus of claim 11, wherein
the latent image obtaining unit feeds the obtained latent image back to the non-uniform motion blur information estimating unit, and
the non-uniform motion blur information estimating unit updates the non-uniform motion blur information using the fed back latent image.

17. The apparatus of claim 16, further comprising:
a final restored image obtaining unit to obtain a final restored image from the multi-frame using the updated non-uniform motion blur information.

18. The apparatus of claim 11, wherein the non-uniform motion blur information estimating unit estimates the non-uniform motion blur information using at least one of a Euclidean transform, and a translational and rotational motion of a camera using an intrinsic parameter of the camera.

19. The apparatus of claim 11, wherein
the non-uniform motion blur information estimating unit estimates the non-uniform motion blur information for a partial region of each image included in the multi-frame, and
the latent image obtaining unit obtains the latent image using non-uniform motion blur information of the partial region.

20. A method of removing a non-uniform motion blur using a multi-frame, the method comprising:
receiving a multi-frame including a non-uniform motion blur;
estimating by a processor non-uniform motion blur information using the multi-frame, the estimating comprising estimating a homography of each image included in the multi-frame and computing a weight of the homography of each image using the estimated homography; and
obtaining a latent image by removing the non-uniform motion blur from the multi-frame using the estimated non-uniform motion blur information, wherein
the estimating of the non-uniform motion blur information and the obtaining of the latent image are repeated in accordance with a predetermined criterion, and
the estimating of the non-uniform motion blur information comprises updating the non-uniform motion blur information using a latent image obtained from a previous iteration.
